(19) United States
(12) Patent Application Publication
(10) Pub. No.: US 2021/0101030 A1
(43) Pub. Date: Apr. 8, 2021

(54) Impact Tools, Systems, and Associated Methods of Use

(71) Applicant: Uniqative LLC, Sylvania, OH (US)

(72) Inventor: Michael Schnell, Westville, IN (US)

(73) Assignee: Uniqative LLC, Sylvania, OH (US)

(21) Appl. No.: 17/061,699

(22) Filed: Oct. 2, 2020

Related U.S. Application Data
(60) Provisional application No. 62/925,260, filed on Oct. 24, 2019.
(60) Provisional application No. 62/910,231, filed on Oct. 3, 2019.

(51) Int. Cl. A62B 3/00; B25D 1/00

(52) U.S. Cl. CPC A62B 3/005; B25D 1/00

(57) ABSTRACT

Impact tools are described herein. An example of an impact tool includes a first elongate member and an impact member. The impact member is attached to the first elongate member and has a first end, a second end, a length that extends from the first end to the second end, a first side, a second side, and a plurality of projections disposed on the second side. Each projection of the plurality of projections has a first end attached to the impact member and a second end. The plurality of projections are configured on the impact member such that at least two projections of the plurality of projections intersect a first hypothetical plane disposed between the impact member second end and the second end of each projection of the plurality of projections.

### FIELD

The disclosure relates generally to the field of tools. More particularly, the disclosure relates to impact tools, impact tool systems, and methods of using an impact tool.

### BACKGROUND

In emergency situations, it is sometimes necessary to gain access to an environment that is not openly accessible. For example, when an automobile is involved in an accident, it may be necessary to break the glass of the automobile to gain access to the automobile's interior and anyone inside the automobile. In another example, when emergency rescue personnel are positioned within a structure, such as a house or commercial building, with no safe exits available, it may be necessary to break the glass of a window to create an exit through which the emergency rescue personnel can exit the structure. However, gaining access to various environments can be difficult depending on the material that forms the glass intended to be broken. For example, laminated glass generally prevents an individual from easily accessing an environment in emergency situations.

Therefore, a need exists for new and useful impact tools, impact tool systems, and methods of using an impact tool.

### SUMMARY OF SELECTED EXAMPLE EMBODIMENTS

Various impact tools, impact tool systems, and methods of using an impact tool are described herein.

An example impact tool includes a first elongate member and an impact member. The first elongate member has a first elongate member first end and a first elongate member second end. The impact member is attached to the first elongate member. The impact member has an impact member first end, an impact member second end, an impact member length that extends from the impact member first end to the impact member second end, an impact member first side, an impact member second side, and a plurality of projections disposed on the impact member second side and along the impact member length. Each projection of the plurality of projections has a first end attached to the impact member and a second end. The plurality of projections is configured on the impact member such that at least two projections of the plurality of projections intersect a first hypothetical plane that is disposed between the impact member second side and the second end of each projection of the plurality of projections.

Another example impact tool includes a first elongate member, an impact member, a first support member, and a second support member. The first elongate member has a first elongate member first end, a first elongate member second end, a first elongate member lengthwise axis, and a first elongate member length that extends from the first elongate member first end to the first elongate member second end. The impact member is attached to the first elongate member second end. The impact member has an L-shaped cross-sectional configuration, an impact member first end, an impact member second end, an impact member lengthwise axis, an impact member length that extends from the impact member first end to the impact member second end, an impact member first side, an impact member second side, and a plurality of projections disposed on the impact member second side and along the impact member length. The impact member length is less than the first elongate member length. Each projection of the plurality of projections has a first end attached to the impact member and a second end. The plurality of projections is configured on the impact member such that at least two projections of the plurality of projections intersect a first hypothetical plane that is disposed between the impact member second end and the second end of each projection of the plurality of projections. Each projection of the plurality of projections has a main body and a tip. The main body is formed of a first material and the tip is formed of a second material that is different than the first material. The first support member is attached to the first elongate member and the impact member. The second support member is attached to the first elongate member and the impact member.

An example impact tool system includes an impact device and an impact tool. The impact device has a handle, a trigger, and a shaft that defines a passageway. The impact tool is partially disposed within the passageway defined by the impact device. The impact tool has a first elongate member and an impact member. The first elongate member has a first elongate member first end and a first elongate member second end. The impact member is attached to the first elongate member. The impact member has an impact member first end, an impact member second end, an impact member length that extends from the impact member first end to the impact member second end, an impact member first side, an impact member second side, and a plurality of projections disposed on the impact member second side and along the impact member length. Each projection of the plurality of projections has a first end attached to the impact member and a second end. The plurality of projections is configured on the impact member such that at least two projections of the plurality of projections intersect a first hypothetical plane that is disposed between the impact member second end and the second end of each projection of the plurality of projections.

An example method of using an impact tool includes the steps of obtaining an impact tool; obtaining an impact device; loading the impact tool into the impact device; positioning the impact device adjacent a surface intended to be damaged; and activating the impact device.

Additional understanding of the example impact tools, impact tool systems, and methods of using an impact tool can be obtained by review of the detailed description, below, and the appended drawings.

### BRIEF DESCRIPTION OF THE DRAWINGS

FIG. 1 is a perspective view of an example impact tool.

FIG. 2 is a perspective view of another example impact tool.

FIG. 3 is front view of the impact tool illustrated in FIG. 2.

FIG. 4 is a side view of a the impact tool illustrated in FIG. 2.

FIG. 5 is a perspective view of an example impact tool system. The impact tool is partially disposed within the impact device and is not contacting the first and second support arms.

FIG. 6 is a side view of the impact tool system illustrated in FIG. 5. The impact tool is partially disposed within the impact device and is not contacting the first and second support arms.

FIG. 7 is another perspective view of the impact tool system illustrated in FIG. 5. The impact tool is partially disposed within the impact device and is not contacting the first and second support arms.

FIG. 8 is a partial view of the impact tool system illustrated in FIG. 5. The impact tool is partially disposed within the impact device and is contacting the first and second support arms.

FIG. 9 is a schematic illustration of an example method of using an impact tool.

FIG. 10 is a perspective view of another example impact tool system. The impact tool is partially disposed within the impact device and is attached to the impact device.

FIG. 11 is a partial perspective view of the impact tool system illustrated in FIG. 10.

FIG. 12 is another partial perspective view of the impact tool system illustrated in FIG. 10.

FIG. 13 is a partial perspective view of the impact tool system illustrated in FIG. 10 disposed adjacent to, and contacting, a surface intended to be damaged.

FIG. 14 is a schematic illustration of another example method of using an impact tool.

FIG. 15 is a partial perspective view of another example impact tool system. The impact tool is partially disposed within the impact device.

FIG. 16 is a partial perspective view of an example surface that has been damaged by the impact tool system illustrated in FIG. 15.

FIG. 17 is a perspective view of another example impact tool system. The impact tool is partially disposed within the impact device.

FIG. 18 is a partial perspective view of the impact tool system illustrated in FIG. 17.

FIG. 19 is another partial perspective view of the impact tool system illustrated in FIG. 17.

FIG. 20 is another partial perspective view of the impact tool system illustrated in FIG. 17.

FIG. 21 is a partial perspective view of another example impact tool.

FIG. 22 is another partial perspective view of the impact tool illustrated in FIG. 21.

FIG. 23 is another partial perspective view of the impact tool illustrated in FIG. 21.

FIG. 24 is another partial perspective view of the impact tool illustrated in FIG. 21.

FIG. 25 is another partial perspective view of the impact tool illustrated in FIG. 21.

FIG. 26 is another partial perspective view of the impact tool illustrated in FIG. 21.

FIG. 27 is another partial perspective view of the impact tool illustrated in FIG. 21.

FIG. 28 is a perspective view of another impact tool system. The impact tool is illustrated free of the impact device.

FIG. 29 is an elevation view of the impact device of the impact tool system illustrated in FIG. 28 free of the housing.

### DETAILED DESCRIPTION

The following detailed description and the appended drawings describe and illustrate various example embodiments of impact tools, impact tool systems, and methods of using an impact tool. The description and illustration of these examples are provided to enable one skilled in the art to make and use an impact tool, an impact tool system, and practice a method of using an impact tool. They are not intended to limit the scope of the claims in any manner.

As used herein, the term “damage” and grammatically related terms refers to shattering, cracking, fracturing, fragmenting, scoring, cutting, breaking, perforating, disrupting, penetrating, and/or puncturing.

As used herein, the phrase “hard edge” refers to a point, such as the point of a cone or another three-dimensional object, and/or an intersection between two surfaces, such as the intersection between two surfaces of a cube or another three-dimensional object. While examples of hard edges have been provided, these examples are not limiting in nature as a hard edge can be defined by any suitable structure.

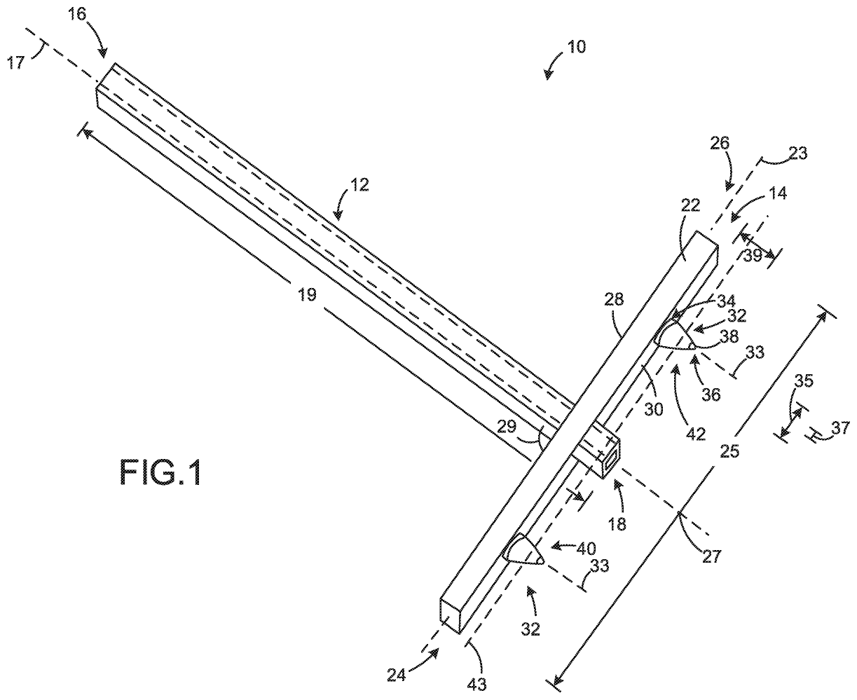

FIG. 1 illustrates an example impact tool 10. The impact tool 10 includes a first elongate member 12 and an impact member 14. The first elongate member 12 has a first elongate member first end 16, a first elongate member second end 18, a first elongate member lengthwise axis 17, and a first elongate member length 19 that extends from the first elongate member first end 16 to the first elongate member second end 18. In the illustrated embodiment, the first elongate member 12 has a rectangular cross-sectional shape, is a tubular member, and is formed of a first material. However, alternative embodiments could include a first elongate member that has any suitable configuration, such as those that have any suitable cross-sectional shape, those that have solid cross-sections, and/or those that are partially hollow.

The impact member 14 is attached to the first elongate member 12 between the first elongate member first end 16 and the first elongate member second end 18. The impact member 14 has an impact member main body 22, an impact member first end 24, an impact member second end 26, an impact member lengthwise axis 23, an impact member length 25 that extends from the impact member first end 24 to the impact member second end 26, an impact member first side 28, an impact member second side 30, and a plurality of projections 32 disposed on the impact member second side 30 and along the impact member length 25. The impact member length 25 has a midpoint 27 and is less than the first elongate member length 19. However in alternative embodiments, an impact member length can be equal to, greater than, less than, or about a first elongate member length. In the illustrated embodiment, the impact member 14 has a solid rectangular cross-sectional shape, is formed of a second material, and is attached to the first elongate member 12 at the midpoint 27 such that the impact member 14 is disposed at an angle 29 equal to about 90 degrees relative to the first elongate member 12. The second material is the same as the first material. While the impact member 14 has been illustrated as having a particular configuration and attached to the first elongate member 12 at an angle 29, alternative embodiments can include an impact member that has any suitable configuration and that is attached to a first elongate member at any suitable angle (e.g., angles between about 45 degrees and about 135 degrees). For example, alternative embodiments can include an impact member that has any suitable cross-sectional shape, that is tubular, partially hollow, attached to any suitable portion of a first elongate member, and/or that is attached to a first elongate member at any suitable location along the length of the impact member.

An impact member can be attached to a first elongate member using any suitable technique or method of attachment and selection of a suitable technique or method of attachment between an impact member and a first elongate member can be based on various considerations, including the intended use of an impact tool and/or the material that forms an impact member. Examples of techniques and methods of attachment considered suitable between a first elongate member and an impact member include welding, fusing, soldering, brazing, using mechanical fasteners, adhesives, snap-fit attachments, threaded attachments, friction fit attachments, combinations of the techniques and methods described herein, and any other technique or method considered suitable for a particular embodiment. In the illustrated embodiment, the impact member 114 is welded to the first elongate member 112.

A first elongate member and an impact member can be formed of any suitable material and selection of a suitable material to form a first elongate member and/or an impact member can be based on various considerations, including the intended use of an impact tool and/or the material that forms a first elongate member and/or impact member. Examples of materials considered suitable to form a first elongate member and/or an impact member include gold, silver, aluminum, zinc, copper, platinum, iron, nickel, steel, such as stainless steel, carbon steel, and hardened steel, glass, cobalt, titanium, chromium, silicon, a ceramic, such as cordierite, silicon nitride, a carbide, such as silicon carbide, tungsten carbide, cemented metal carbide, alumina, and zirconia, diamond, polycrystalline diamond, an alloy, polymers, materials that are buoyant, combinations of the materials described herein, and/or any other material considered suitable for a particular embodiment.

Each projection of the plurality of projections 32 extends from the impact member main body 22 and away from the impact member lengthwise axis 23. Each projection of the plurality of projections 32 has a lengthwise axis 33, a first end 34, a second end 36, a first diameter 35 at the first end 34, a second diameter 37 at the second end 36, a length 39 that extends from the first end 34 to the second end 36, and a solid cross-sectional shape. The first diameter 35 is greater than the second diameter 37 such that the diameter of each projection of the plurality of projections 32 tapers from the first end 34 toward the second end 36. Each projection of the plurality of projections 32 is formed of a third material that is the same as the second material. Any suitable material can be used to form a projection, such as those described herein. The second end 36 of each projection of the plurality of projections 32 is configured such that it defines at least one hard edge 38. The inclusion of at least one hard edge 38 on each projection of the plurality of projections 32 provides a mechanism for increasing the likelihood of the impact tool 10 damages the material that forms the surface intended to be contacted by the impact tool 10. The plurality of projections 32 is configured on the impact member 14 such that at least two projections (e.g., a first projection 40 of the plurality of projections 32 and a second projection 42 of the plurality of projections 32) intersect a first hypothetical plane 43 disposed between the impact member 14 (e.g., impact member second side 30) and the second end of each projection of the plurality of projections 32.

An impact tool 10 that has a plurality of projections 32 positioned as described herein provides a mechanism for damaging glass, such as laminated glass, or any other suitable material, such that emergency action can be taken within the environment beyond the glass, as desired. The impact tools described herein provide increased handleability relative to other tools used to damage glass. Unlike other devices, the impact tools described herein provide a mechanism for ensuring that at least two projections of a plurality of projections contact a surface that the impact tool is intended to be used on such that the material that forms the surface (e.g., laminated glass) can be damaged by the impact tool.

A first elongate member, an impact member, and/or each projection of the plurality of projections can be formed using any suitable technique or method of manufacture and selection of a suitable technique or method of manufacture to form a first elongate member, an impact member, and/or a projection can be based on various considerations, including the intended use of the impact tool. Examples of suitable techniques and methods of manufacturing a first elongate member, an impact member, and/or a projection include casting, forming, forging, and any other technique or method of manufacture considered suitable for a particular embodiment.

While each projection of the plurality of projections 32 has been illustrated and described as being formed as a part of a single continuous component of the impact member and as being formed of the same material that forms the first elongate member and the impact member, a projection, a portion of a plurality of projections, or each projection of a plurality of projections can be formed of any suitable material and selection of a suitable material to form a projection, a portion of a plurality of projections, or each projection of a plurality of projections can be based on various considerations, including the intended use of an impact tool. Examples of materials considered suitable to form a projection, a portion of a plurality of projections, or each projection of a plurality of projections include a third material that is the same as, or different than, the first material, a third material that is the same as, or different than, the second material, and any other material considered suitable for a particular embodiment. For example, a first projection of a plurality of projections, or a first set of projections of a plurality of projections, can be formed of a third material and a second projection of a plurality of projections, or a second set of projection of a plurality of projections, can be formed of a fourth material that can be the same as the third material or different than the third material.

While the impact tool 10 has been illustrated as having a plurality of projections 32, an impact tool can include any suitable number of projections and selection of a suitable number of projections to include on an impact tool can be based on various considerations, including the intended use of the impact tool. Examples of numbers of projections considered suitable to include on an impact tool include one, at least one, two, a plurality, three, four, five, six, seven, eight, nine, ten, eleven, twelve, thirteen, fourteen, fifteen, more than fifteen, sixteen, seventeen, eighteen, nineteen, twenty, twenty-one, twenty-two, twenty-three, twenty-four, twenty-five, twenty-six, twenty-seven, twenty-eight, twenty-nine, thirty, more than thirty, and any other number of projections considered suitable for a particular embodiment.

While the plurality of projections 32 has been illustrated as configured such that at least two projections (e.g., a first projection 40 of the plurality of projections 32 and a second projection 42 of the plurality of projections 32) intersect a first hypothetical plane 43 disposed between the impact member 14 (e.g., impact member second side 30) and the second end of each projection of the plurality of projections 32, the projections of a plurality of projections can be configured in any suitable configuration. Selection of a suitable configuration for a plurality of projections can be based on various considerations, such as the intended use of an impact tool on which the plurality of projections is disposed.

While each projection of the plurality of projections 32 has been illustrated as including at least one hard edge 38, a projection, a portion of a plurality of projections, or each projection of a plurality of projections can include any suitable number of hard edges and selection of a suitable number of hard edges to include on a projection, a portion of a plurality of projections, or each projection of a plurality of projections can be based on various considerations, including the material forming the surface intended to be contacted by an impact tool. Examples of numbers of hard edges considered suitable to include on a projection, a portion of a plurality of projections, or each projection of a plurality of projections include at least one, one, two, a plurality, three, four, five, six, seven, eight, nine, ten, such that the second end of a projection, a portion of a plurality of projection, or each projection of a plurality of projections, is multifaceted, such that a projection, a portion of a plurality of projections, or each projection of a plurality of projections defines one or more hard edges between the first end and the second end of the projection, and any other number of hard edges considered suitable for a particular embodiment. While a hard edge has been illustrated as included on each projection of the plurality of projections, a projection can alternatively, or in combination with a hard edge, include a rounded point, or any other structure that provides a mechanism for damaging a surface intended to be contacted by a projection of the plurality of projections.

While each projection of the plurality of projections 32 has been illustrated as having a first diameter 35 that is greater than the second diameter 37 such that the diameter of each projection of the plurality of projections 34 tapers from the first end 34 toward the second end 36, each projection included on an impact tool can have any suitable structural arrangement. Selection of a suitable structural arrangement for a projection included on an impact tool can be based on various considerations, including the intended use of the impact tool. Examples of structural arrangements considered suitable for a projection include projections that have a first diameter at a first end of the projection that is greater than a second diameter at a second end of the projection such that the diameter of the projection tapers from the first end toward the second end, a first diameter at a first end of the projection that is less than a second diameter at a second end of the projection such that the diameter of the projection tapers from the second end toward the first end, a first diameter at a first end of the projection that is equal to, or substantially equal to, a second diameter at a second end of the projection, projections that are hollow and define a chamber that is accessible from an environment exterior to the chamber, projections that are hollow and define a chamber that is not accessible from an environment exterior to the chamber, and any other structural arrangement considered suitable for a particular embodiment.

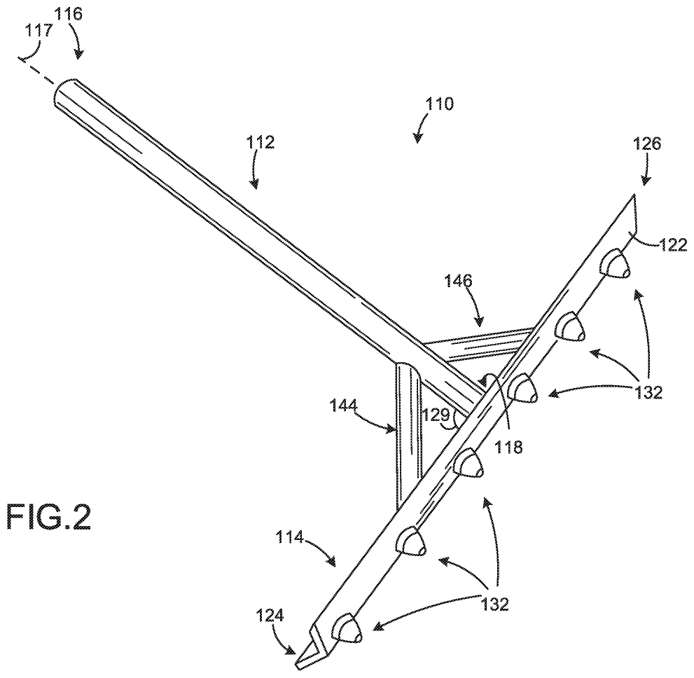

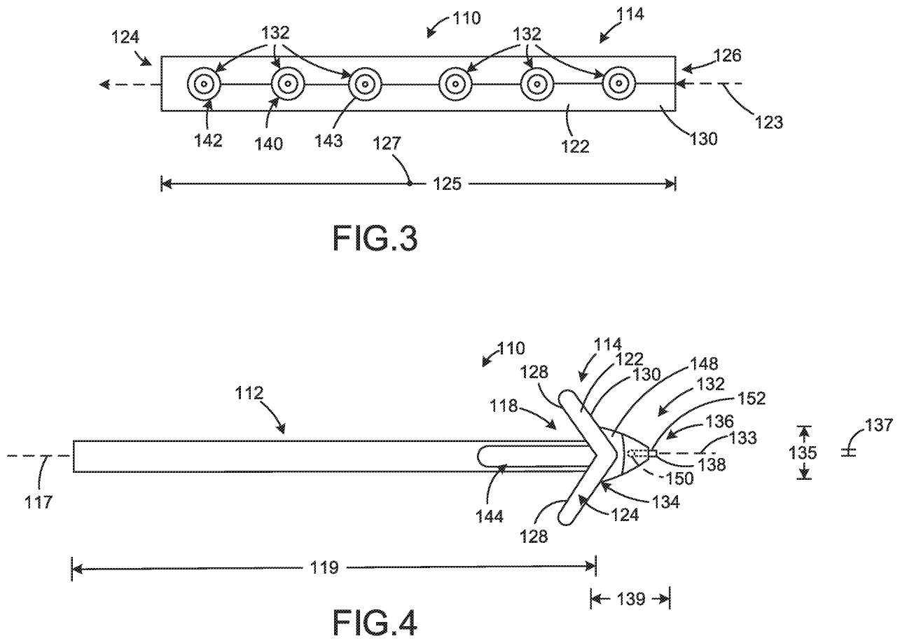

FIGS. 2, 3, and 4 illustrate another example impact tool 110. The impact tool 110 is similar to the impact tool 10 illustrated in FIG. 1 and described above, except as detailed below. The impact tool 110 includes a first elongate member 112, an impact member 114, a first support member 144, and a second support member 146.

The first elongate member 112 has a first elongate member first end 116, a first elongate member second end 118, a first elongate member lengthwise axis 117, and a first elongate member length 119 that extends from the first elongate member first end 116 to the first elongate member second end 118. In the illustrated embodiment, the first elongate member 112 comprises a cylindrical member that has a solid cross-section and is formed of a first material.

The impact member 114 has an impact member main body 122, an impact member first end 124, an impact member second end 126, an impact member lengthwise axis 123, an impact member length 125 that extends from the impact member first end 124 to the impact member second end 126, an impact member first side 128, an impact member second side 130, and a plurality of projections 132 disposed on the impact member second side 130 and along the impact member length 125. The impact member length 125 has a midpoint 127. In the illustrated embodiment, the impact member 114 has an L-shaped cross-sectional configuration and is attached to the first elongate member second end 118 at the midpoint 127 such that the impact member 114 is disposed at an angle 129 equal to about 90 degrees relative to the first elongate member 112. The impact member 114 is formed of a second material that is the same as the first material. However, in alternative embodiments, the second material can be different than the first material.

Each projection of the plurality of projections 132 is equally spaced from an immediately adjacent projections of the plurality of projections 114. For example, a first projection 140 is equally spaced from a second projection 142 and a third projection 143. Each projection of the plurality of projections 132 extends from the impact member main body 122 and away from the impact member lengthwise axis 123 and comprises a separate component attached (e.g., releasably, fixedly) to the impact member 114. Each projection of the plurality of projections 132 has a lengthwise axis 133, a first end 134, a second end 136, a first diameter 135 at the first end 134, a second diameter 137 at the second end 136, a length 139 that extends from the first end 134 to the second end 136, and a main body 148 that defines a recess 150, and a tip 152 disposed within the recess 150. The recess 150 extends from the second end 136 toward the first end 134 and is sized and configured to receive a portion of a tip 152. The tip 152 is fixedly attached to the main body 148 within the recess 150, has a hard edge 138, and can be formed of any suitable material, such as those described herein. In addition, while the tip 152 has been described as being fixedly attached to the main body 148, a tip can be attached to a main body of a projection using any suitable technique or method of attachment, such as those described herein. In the illustrated embodiment, each projection of the plurality of projections 132 is welded to the impact member 114. However, in alternative embodiments, a portion of a plurality of projections, or each projection in a plurality of projections can be attached to an impact member using any suitable technique or method of attachment, such as those described herein. In the illustrated embodiment, the main body 148 of each projection of the plurality of projections 132 is formed of a third material and the tip 152 of each projection of the plurality of projections 132 is formed of a fourth material. The third material is different than the second material and the fourth material. The first material is stainless steel, the second material is stainless steel, the third material is an alloy, and the fourth material is tungsten carbide. However, in alternative embodiments, the third material can be the same as the first material and/or the second material.

The first support member 144 is attached to the first elongate member 112 and the impact member 114. The second support member 146 is attached to the first elongate member 112 and the impact member 114. In the illustrated embodiment, each of the first support member 144 and the second support member 146 comprises a cylindrical member that has a solid cross-section. However, alternative embodiments could include a first support member and/or a second support member that has any suitable configuration, such as those that have any suitable cross-sectional shape, those that have solid cross-sections, those that are tubular, and/or those that are partially hollow. In the illustrated embodiment, each of the first support member 144 and second support member 146 is formed of stainless steel and is welded to the first elongate member 112 and the impact member 114. However, a first support member and/or second support member can be formed of any suitable material and attached to a first elongate member and/or an impact member using any suitable technique or method of attachment, such as the materials, techniques, and methods described herein.

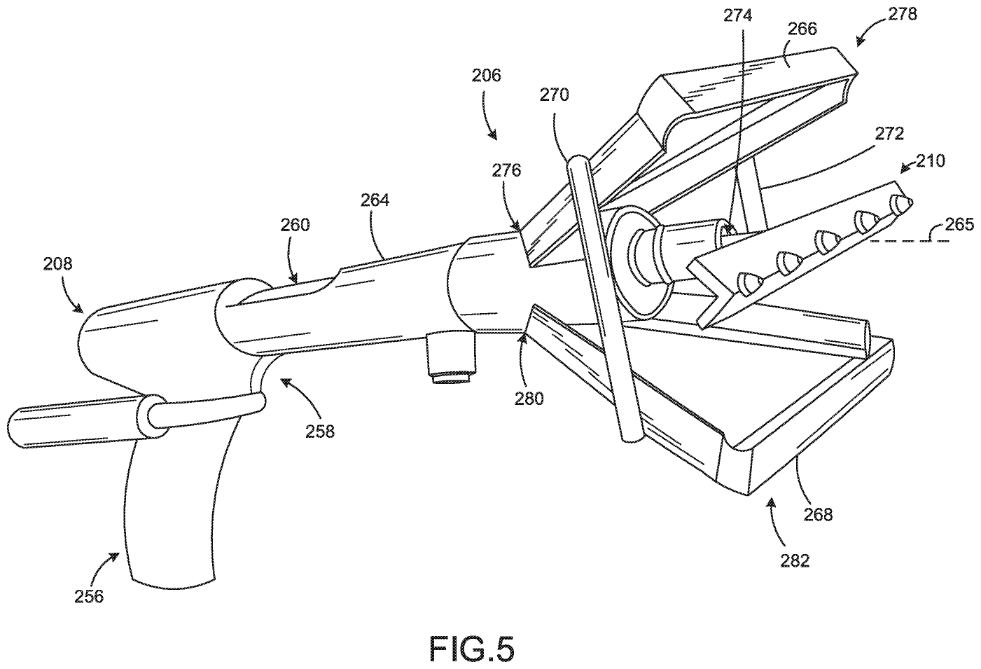

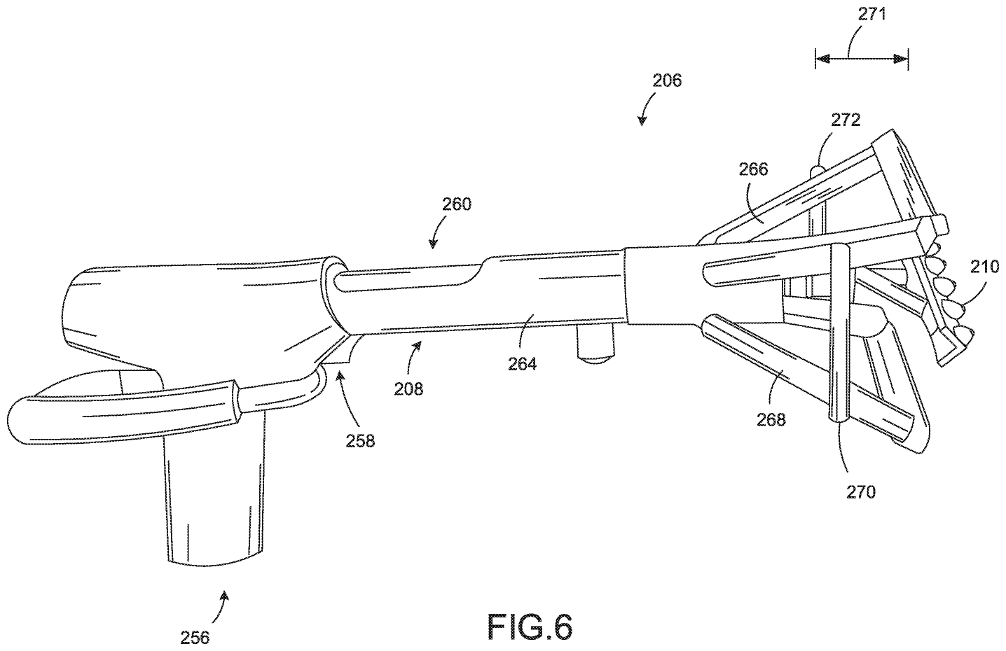

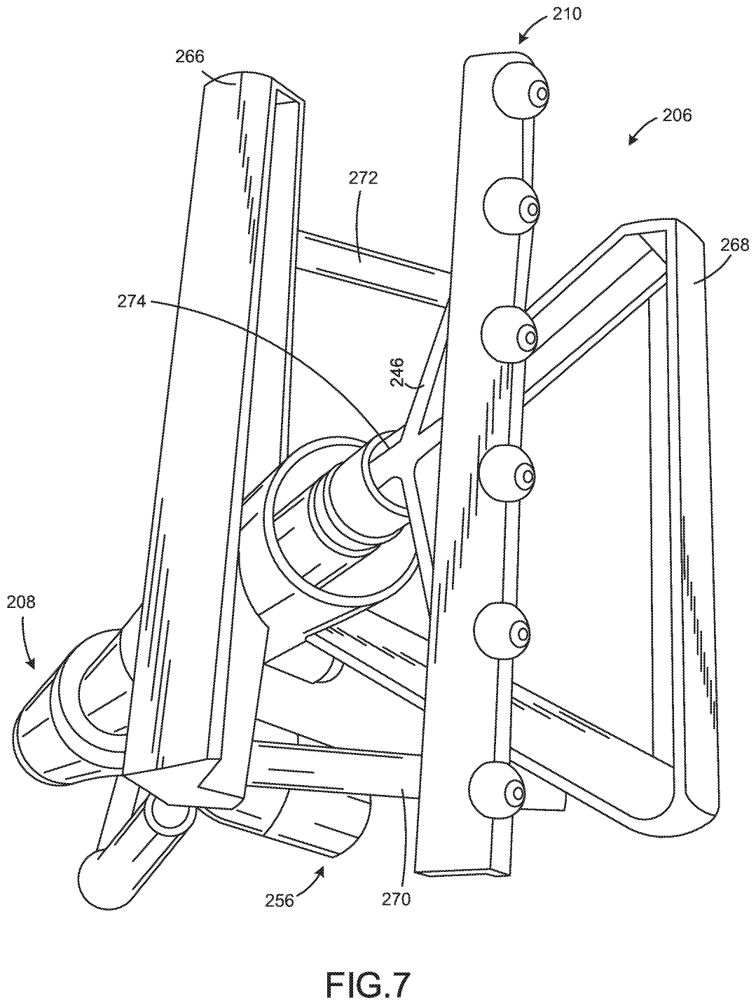

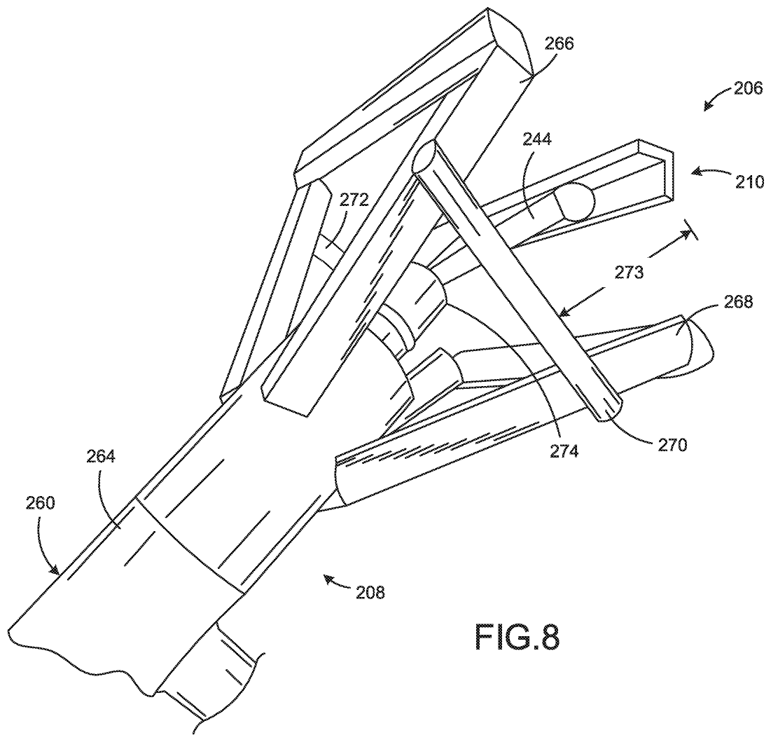

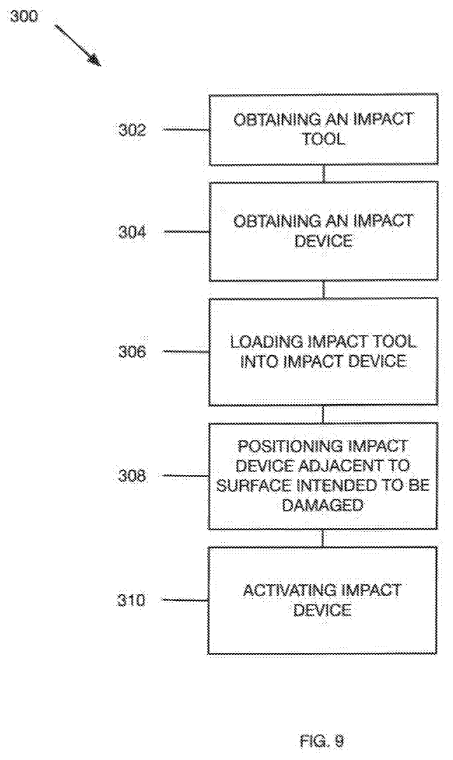

FIGS. 5, 6, 7, and 8 illustrate an example impact tool system 206. The impact tool system 206 includes an impact device 208 and an impact tool 210. The impact tool 210 is similar to the impact tool 110 illustrated in FIGS. 2, 3, and 4 and described above, except as detailed below. While impact tool 210 has been illustrated as included in impact tool system 206, any suitable impact tool can be included in an impact tool system, such as those described herein.

In the illustrated embodiment, the impact device 208 comprises a handle 256, a trigger 258, and a shaft 260. The trigger 258 is moveable from a first position to a second position. In the illustrated embodiment, the shaft 260 comprises an elongate member 264, a first support member 266, a second support member 268, a first support arm 270, and a second support arm 272. The elongate member 264 extends from the handle 256, has a lengthwise axis 265, and defines a passageway 274 that is sized and configured to receive a portion of the impact tool 210. The first support member 266 extends from the elongate member 264 and away from the lengthwise axis 265 of the elongate member 264. The first support member 266 has a first end 276 and a second end 278. The second support member 268 extends from the elongate member 264 and away from the lengthwise axis 265 of the elongate member 264. The second support member 268 has a first end 280 and a second end 282. The first support arm 270 is attached to each of the first support member 266 and second support member 268. The second support arm 272 is attached to each of the first support member 266 and second support member 268. Each of the first support arm 270 and the second support arm 272 is disposed a distance 271 from the second end 278 of the first support arm 266. The distance 271 is greater than the length 273 of the impact tool 210 that extends from the impact member 214 to the point where the impact tool 210 contacts the shaft 260 when loaded within the impact device 208, as described in more detail herein. This provides a mechanism for loading the impact tool 110 such that is it recessed relative to the shaft 260 prior to being used.

To load the impact tool 210 into the impact device 208, a user applies a force on the impact tool 210 directed toward the passageway 274 until the first elongate member first end is inserted into the passageway 274 and the first support member 244 contacts the first support arm 270 and the second support member 246 contacts the second support arm 272. In alternative embodiments, such as when impact tool 10 is being used, a user applies a force on the impact tool 10 directed toward the passageway 274 until the first elongate member first end 16 is inserted into the passageway 274 and the impact member 14 contacts each of the first support arm 270 and the second support arm 272. Subsequently, when the impact device 208 is loaded and ready for use using conventional techniques (e.g., for low velocity piston type fastening tools), the user positions the impact device 208 on the surface intended to be damaged and applies a force on the trigger 258 such that it moves from its first position to its second position and the impact tool 110 moves from a first position, in which it is stored within the impact device 208, to a second position, in which it is forced out of the passageway 274 and damages the surface intended to be damaged.

Various methods of using an impact tool are described herein. While the methods described herein are shown and described as a series of acts, it is to be understood and appreciated that the methods are not limited by the order of acts, as some acts may in accordance with these methods, occur in the order shown and/or described, in different orders, and/or concurrently with other acts described herein.

FIG. 9 is a schematic illustration of an example method 300 of using an impact tool.

A step 302 comprises obtaining an impact tool. Another step 304 comprises obtaining an impact device. Another step 306 comprises loading the impact tool into the impact device. Another step 308 comprises positioning the impact device adjacent to a surface intended to be damaged. Another step 310 comprises activating the impact device.

Step 302 can be accomplished by obtaining any suitable impact tool, such as impact tool 10, impact tool 110, or any other impact tool considered suitable for a particular embodiment.

Step 304 can be accomplished by obtaining any suitable impact device, such as impact device 208, or any other impact device considered suitable for a particular embodiment.

Step 306 can be accomplished by applying a force on the impact tool directed toward a passageway defined by a shaft of the impact device until a first elongate member first end of the impact tool is inserted into the passageway. An optional step comprises continuing the application of a force on the impact tool directed toward the passageway until a first support member of the impact tool contacts a first support arm of the shaft. Alternatively, in embodiments in which impact tool 10 is being used, an optional step comprises continuing the application of a force on the impact tool directed toward the passageway until the impact member contacts each of the first support arm and the second support arm of the shaft of the impact device.

Step 308 can be accomplished by applying a force on the impact device directed toward the surface intended to be damaged until a portion of the impact device (e.g., first support member, second support member) and/or the impact tool (e.g., impact member) is disposed adjacent to the surface intended to be damaged. Alternatively, step 308 can comprise positioning the impact device adjacent a surface intended to be damaged such that it contacts the surface intended to be damaged. This alternative step can be accomplished by applying a force on the impact device directed toward the surface intended to be damaged until a portion of the impact device (e.g., first support member, second support member) and/or the impact tool (e.g., impact member) contacts the surface intended to be damaged.

Step 310 can be accomplished by applying a force on the trigger of the impact device such that it moves from its first position to its second position and the impact tool moves from a first position, in which a is stored within the impact device, to a second position, in which it is forced out of the passageway and damages the surface intended to be damaged. In the first position, a first portion of the length of the first elongate member is disposed within the passageway defined by the impact device. In the second position, a second portion of the length of the first elongate member is disposed within the passageway defined by the impact device that is less than the first portion of the length of the first elongate member. In embodiments in which the impact device is not loaded and ready for use, an optional step comprises loading the impact device. This optional step can be accomplished using conventional techniques for loading an impact device.

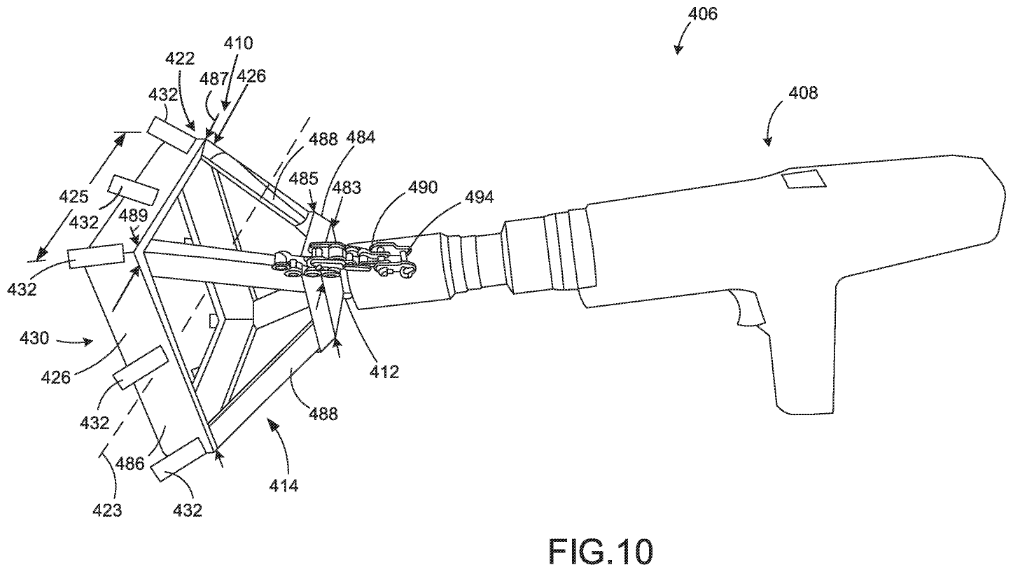

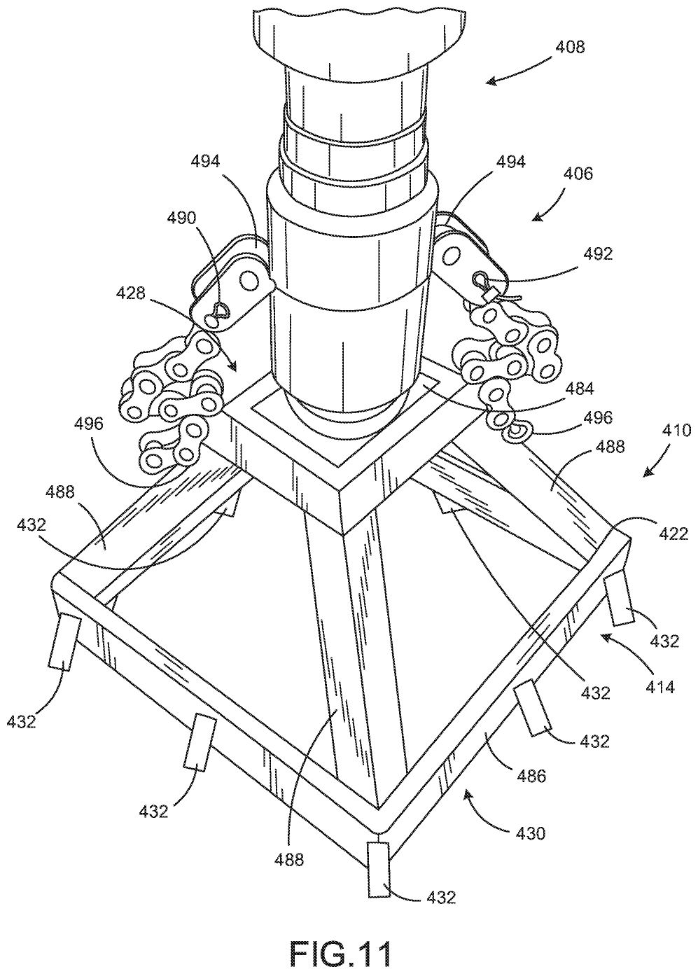

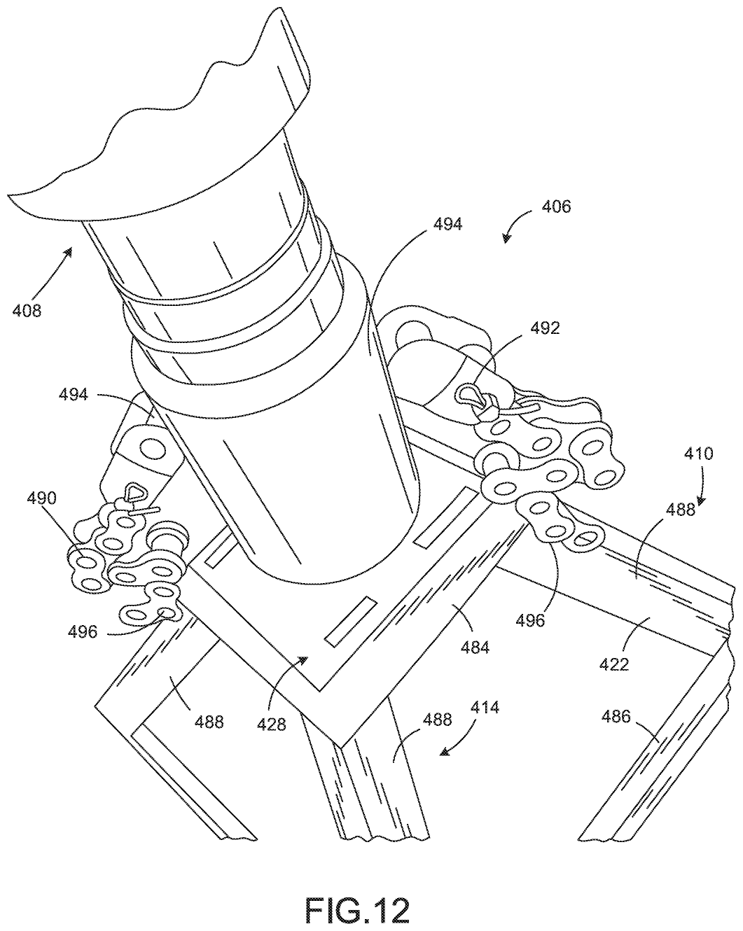

FIGS. 10, 11, 12, and 13 illustrate another example impact tool system 406. The impact tool system 406 is similar to the impact tool system 206 illustrated in FIGS. 5, 6, 7, and 8 and described above, except as detailed below. The impact tool system 406 includes an impact device 408 and an impact tool 410. The impact tool 410 is similar to the impact tool 110 illustrated in FIGS. 2, 3, and 4 and described above, except as detailed below.

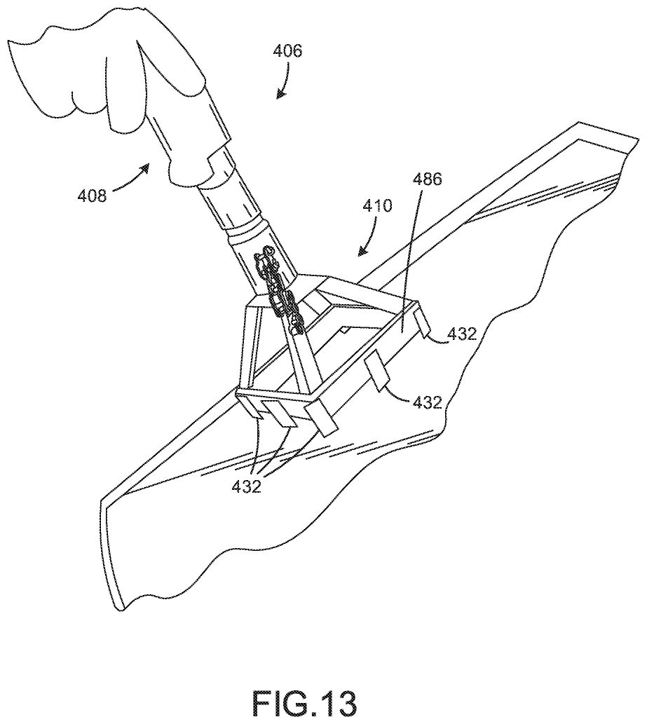

The impact tool 410 includes a first elongate member 412 and an impact member 414. In the illustrated embodiment, the impact member 414 has an impact member main body 422, an impact member first end 424, an impact member second end 426, an impact member lengthwise axis 423, an impact member length 425 that extends from the impact member first end 424 to the impact member second end 426, an impact member first side 428, an impact member second side 430, an impact member first frame 484, an impact member second frame 486, a plurality of impact member support members 488, and a plurality of projections 432 disposed on the impact member second side 430 and along the impact member length 425. As shown best in FIG. 13, each projection of the plurality of projections 432 is attached to the impact member second frame 486.

In the illustrated embodiment, the impact member first frame 484 has a length 483, a width 485, a rectangular cross-sectional configuration, is attached to the first elongate member 412, and is attached to each impact member support member of the plurality of impact member support members 488. The impact member second frame 486 has a length 487, a width 489, a rectangular cross-sectional configuration and is attached to each impact member support member of the plurality of impact member support members 488. The length 483 and width 485 of the impact member first frame 484 are equal to one another and less than the length 487 and width 489 of the impact member second frame 486. Each impact member support member of the plurality of impact member support members 488 is attached to each of the impact member first frame 484 and the impact member second frame 486. Any suitable technique or method of attachment can be used to accomplish the attachments described herein, such as the techniques and methods described herein.

While each of the impact member first frame 484 and the impact member second frame 486 has been illustrated as having a rectangular cross-sectional configuration, an impact member frame can have any suitable cross-sectional configuration and selection of a suitable cross-sectional configuration for an impact member frame can be based on various considerations, including the intended use of an impact member. Examples of cross-sectional configurations considered suitable for an impact member include rectangular, circular, triangular, and any other cross-sectional configuration considered suitable for a particular embodiment.

In the illustrated embodiment, the impact tool 410 is releasably attached to the impact device 408 using a first chain 490 and a second chain 492. Each of the first chain 490 and the second chain 492 has a first end 494 attached to the impact device 408 and a second end 496 attached to the impact member 414. The inclusion of a first chain 490 and a second chain 492 provides a mechanism for maintaining attachment between the impact device 408 and impact tool 410 during use such that the impact tool 410 does not get lost and the impact tool system 406 can be used multiple times without having to reload the impact tool 410.

While a first chain 490 and a second chain 492 have been illustrated as accomplishing releasable attachment between the impact device 408 and the impact tool 410, any suitable type of attachment and structure can be used to provide attachment between an impact device and an impact tool. Selection of a suitable type of attachment and a suitable structure to accomplish attachment between an impact device and an impact tool can be based on various considerations, including the intended use of the impact tool system of which the impact device and impact tool are included. Examples of types of attachment considered suitable between an impact device and an impact tool include permanent attachments, releasable attachments, and any other type of attachment considered suitable for a particular embodiment. Examples of structures considered suitable to accomplish attachment between an impact device and an impact tool include chains, wire members, pivoting members, and any other structure considered suitable for a particular embodiment.

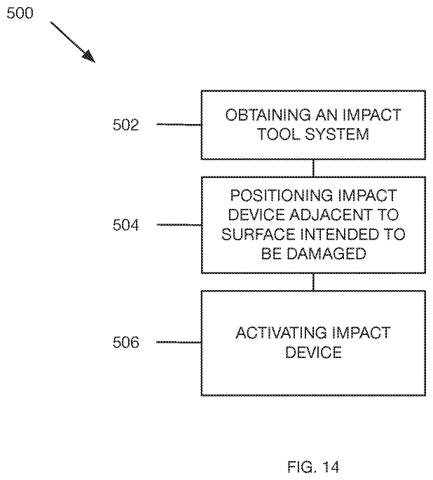

FIG. 14 is a schematic illustration of an example method 500 of using an impact tool.

A step 502 comprises obtaining an impact tool system. The impact tool system comprises an impact device and an impact tool attached to the impact device. Another step 504 comprises positioning the impact device adjacent to a surface intended to be damaged. Another step 506 comprises activating the impact device.

Step 502 can be accomplished by obtaining any suitable impact tool system, such as impact tool system 406, or any other impact tool system considered suitable for a particular embodiment.

Step 504 can be accomplished by applying a force on the impact device directed toward the surface intended to be damaged until a portion of the impact tool (e.g., impact member, impact member second frame) is disposed adjacent to the surface intended to be damaged. Alternatively, step 504 can comprise positioning the impact device adjacent a surface intended to be damaged such that it contacts the surface intended to be damaged. This alternative step can be accomplished by applying a force on the impact device directed toward the surface intended to be damaged until a portion of the impact tool (e.g., impact member, impact member second frame) contacts the surface intended to be damaged.

Step 506 can be accomplished by applying a force on the trigger of the impact device such that it moves from its first position to its second position and the impact tool moves from a first position, in which it is stored within the impact device, to a second position, in which it is forced out of the passageway and damages the surface intended to be damaged. In the first position, a first portion of the length of the first elongate member is disposed within the passageway defined by the impact device. In the second position, a second portion of the length of the first elongate member is disposed within the passageway defined by the impact device that is less than the first portion of the length of the first elongate member. Optionally, each of step 504 and step 506 can be repeated in situations in which it is desired to further damage the surface intended to be damaged.

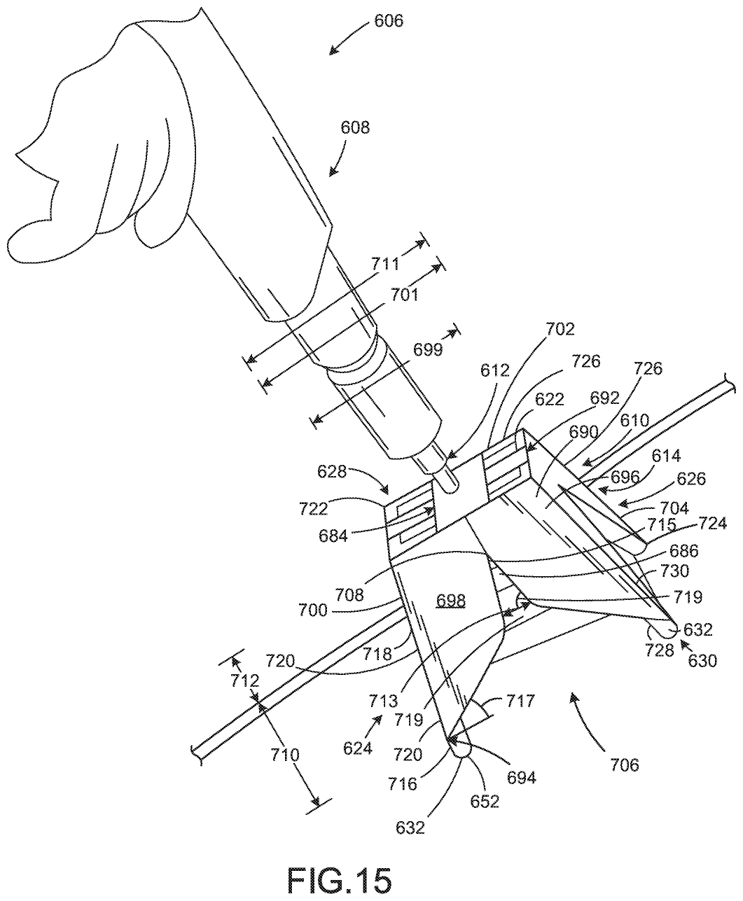

FIG. 15 illustrates another example impact tool system 606. The impact tool system 606 is similar to the impact tool system 406 illustrated in FIGS. 10, 11, 12, and 13 and described above, except as detailed below. The impact tool system 606 includes an impact device 608 and an impact tool 610. The impact tool 610 is similar to the impact tool 410 illustrated in FIGS. 10, 11, 12, and 13 and described above, except as detailed below.

The impact tool 610 includes a first elongate member 612 and an impact member 614. In the illustrated embodiment, the impact member 614 has an impact member main body 622, an impact member first end 624, an impact member second end 626, an impact member first side 628, an impact member second side 630, an impact member first frame 684, an impact member second frame 686, a plurality of impact member support members (not shown), a plurality of projections 632 disposed on the impact member second side 630 and along the impact member length, and a casing 690. As shown in FIG. 15, each projection of the plurality of projections 632 is attached to the casing 690. In the illustrated embodiment, the impact member first frame 684, the impact member second frame 686, and the impact member support members are similar to the impact member first frame 484, impact member second frame 486, and impact member support members 488 described with respect to FIGS. 10, 11, 12, and 13.

In the illustrated embodiment, the casing 690 is attached to each of impact member first frame 684 and the impact member second frame 686. The casing 690 has a first end 692, a second end 694, and a main body 696 that defines a first side 698, a second side 700, a third side 702, and a fourth side 704. The first side is disposed at a 90 degree angle relative to the second side 700 and the fourth side 704. The second side 700 is disposed at a 90 degree angle relative to the first side 698 and the third side 702. The third side 702 is disposed at a 90 degree angle relative to the second side 700 and the fourth side 704. The fourth side 704 is disposed at a 90 degree angle relative to the third side 702 and the first side 698. However, alternative embodiments can include a main body that defines the sides at any suitable angle (e.g., less than 90 degrees, greater than 90 degrees) relative to one another. Each of the first side 698, the second side 700, the third side 702, and the fourth side 704 has a first length 699 at the first end 692 and a second length 701 at the second end 694 that is greater than the first length 699. The main body 696 defines a recess 706 on each of the first side 698, the second side 700, the third side 702, and the fourth side 704. The recess 706 extends from the second end 694 toward the first end 692 to a recess base 708. The recess 706 has a first portion 710 that extends from the second end 694 toward the recess base 708 and a second portion 712 that extends from the first portion 710 to the recess base 708. The width of the first portion 710 tapers from the second end 694 to the second portion 712. The width of the second portion 712 tapers from the first portion 710 to the recess base 708. The first portion 710 has a first width 711 at the second end 694, the second portion 712 has a second width 713 at the location the first and second portions 710, 712 meet, and the recess base 708 has a third width 715. The first width 711 is greater than the second width 713 and the second width 713 is greater than the third width 715. In the illustrated embodiment, the main body 696 converges from the second end 694 toward the first end 692 along the first portion 710 at angles 717 equal to about 45 degrees and converges from the location at which the first and second portions 710, 712 meet toward the recess base 708 along the second portion 712 at angles 719 that are less than 45 degrees.

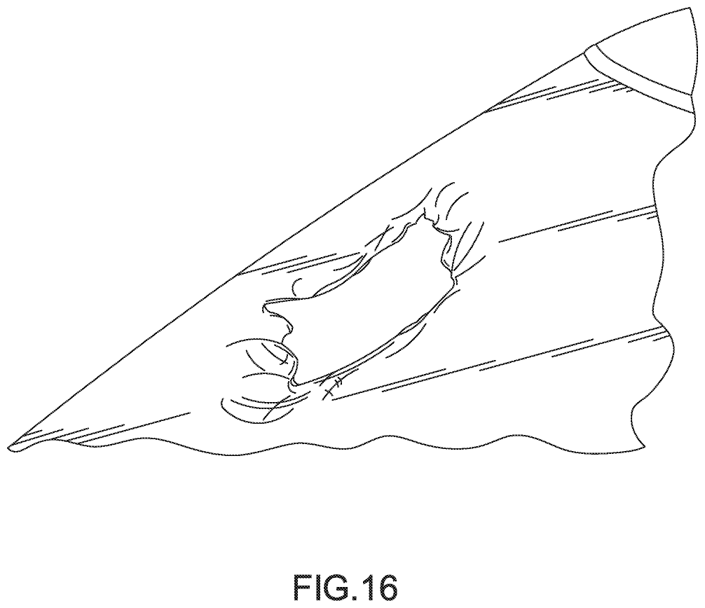

Each projection of the plurality of projections 632 is attached to the casing 690 and has a carbide tip 652. A first projection 716 of the plurality of projections 632 is disposed at a first corner 718 defined by the casing 690. A second projection 720 of the plurality of projections 632 is disposed at a second corner 722 defined by the casing 690. A third projection 724 of the plurality of projections 632 is disposed at a third corner 726 defined by the casing 690. A fourth projection 728 of the plurality of projections 632 is disposed at a fourth corner 730 defined by the casing 690. The structural arrangement of the casing 690 and the plurality of projections 632 provides a mechanism for increasing the total damage imparted on a surface intended to be damaged. For example, during use, after each projection of the plurality of projections 632 has initially damaged a surface intended to be damaged, the casing 690 provides a mechanism for continuing the damage imparted by the impact tool 610 as the impact tool 610 is driven through the surface being damaged. FIG. 16 shows the total damage created by impact tool 610.

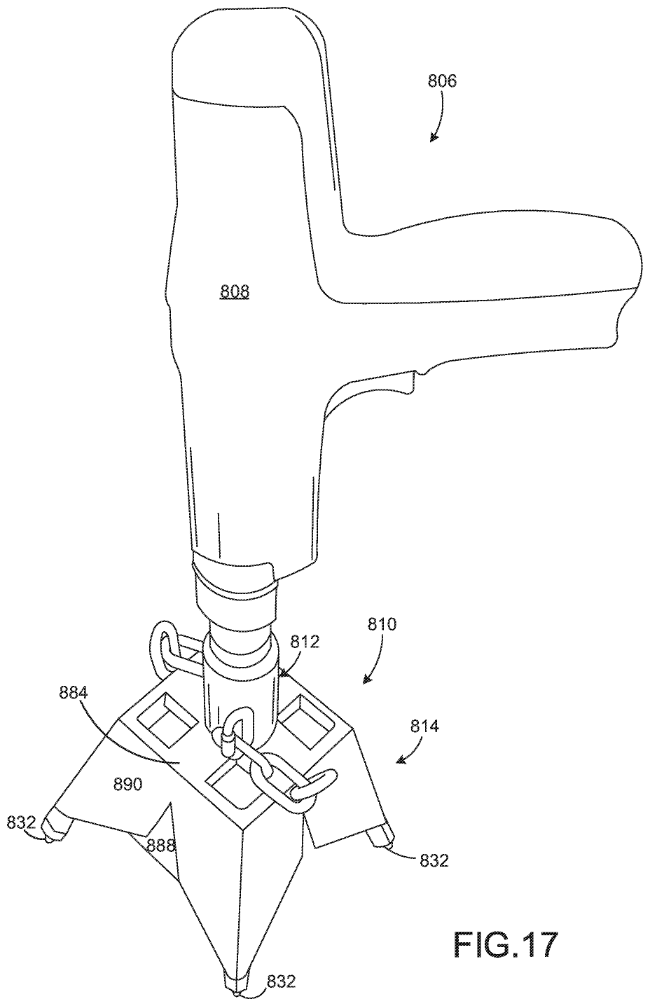

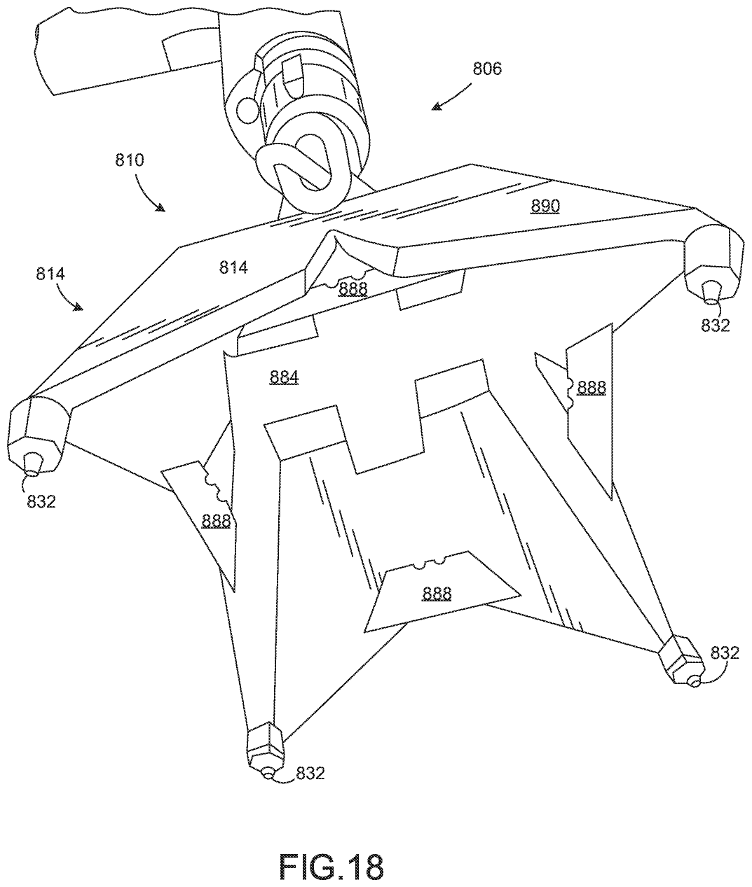

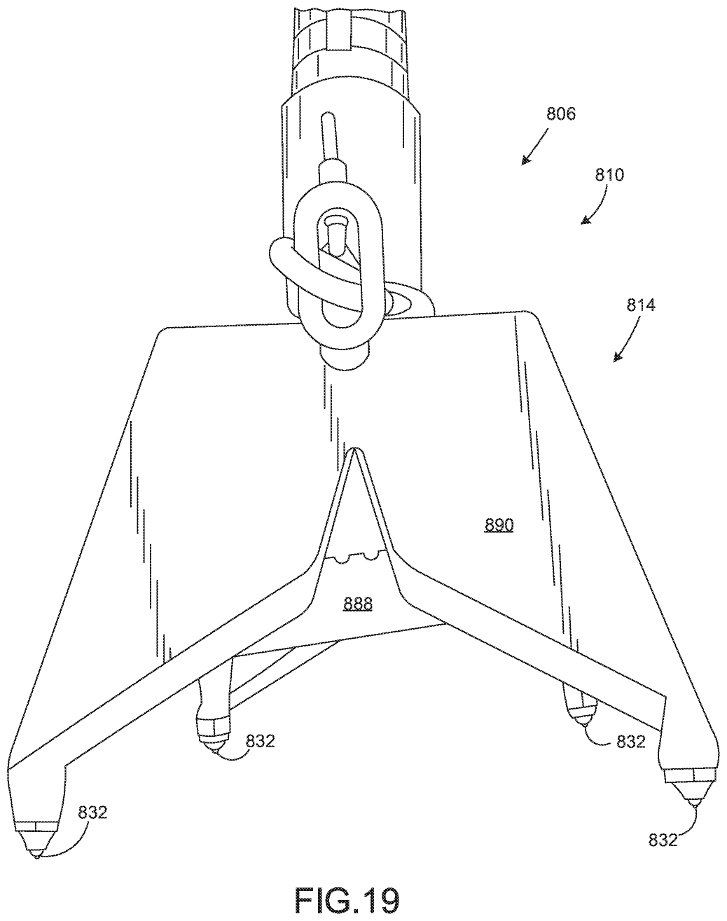

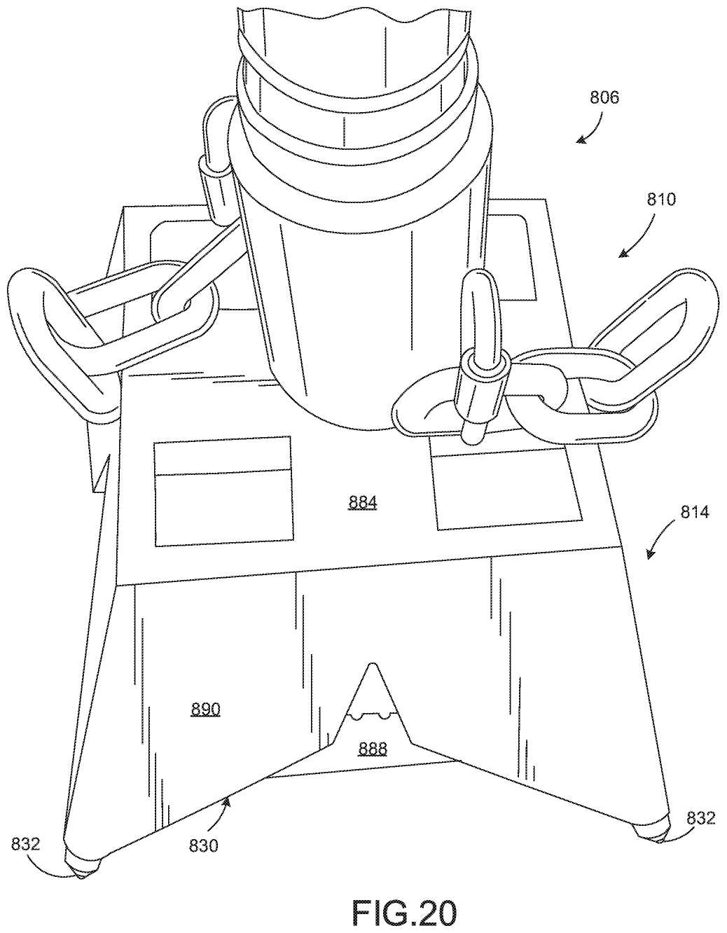

FIGS. 17, 18, 19, and 20 illustrate another example impact tool system 806. The impact tool system 806 is similar to the impact tool system 606 illustrated in FIG. 15 and described above, except as detailed below. The impact tool system 806 includes an impact device 808 and an impact tool 810. The impact tool 810 is similar to the impact tool 610 illustrated in FIG. 15.

In the illustrated embodiment, the impact tool 810 includes a first elongate member 812 and an impact member 814. The impact member 814 has an impact member first frame 884, a plurality of impact member support members 888, a plurality of projections 832 disposed on the impact member second side 830, and a casing 890.

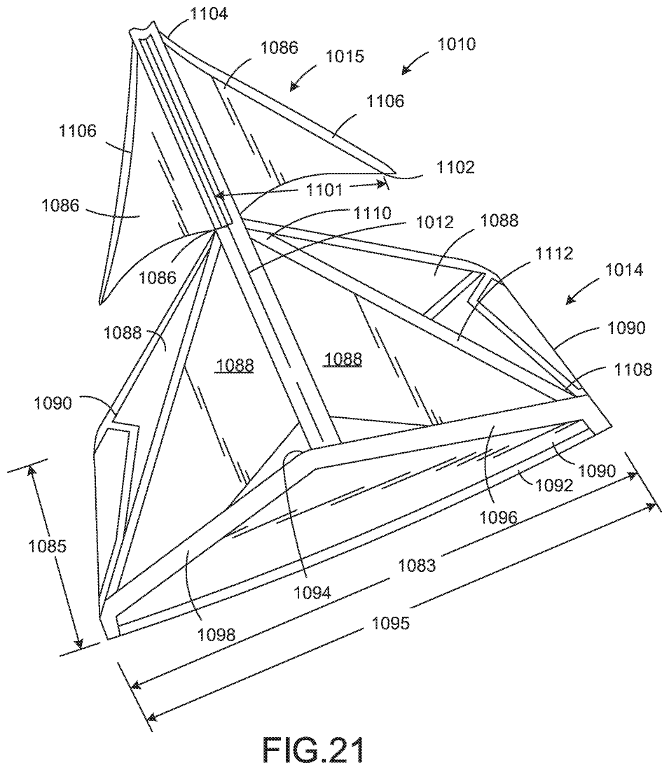

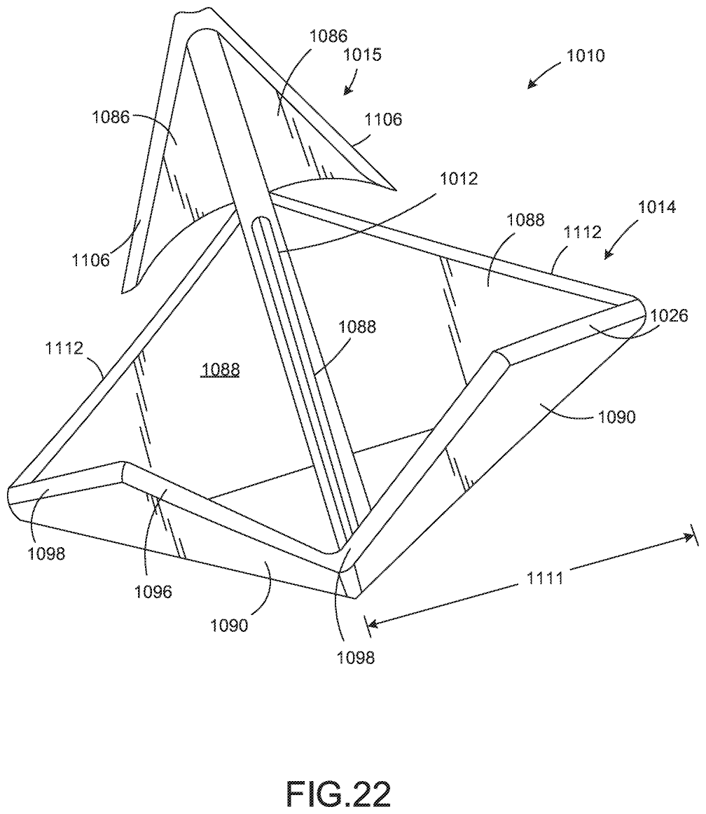

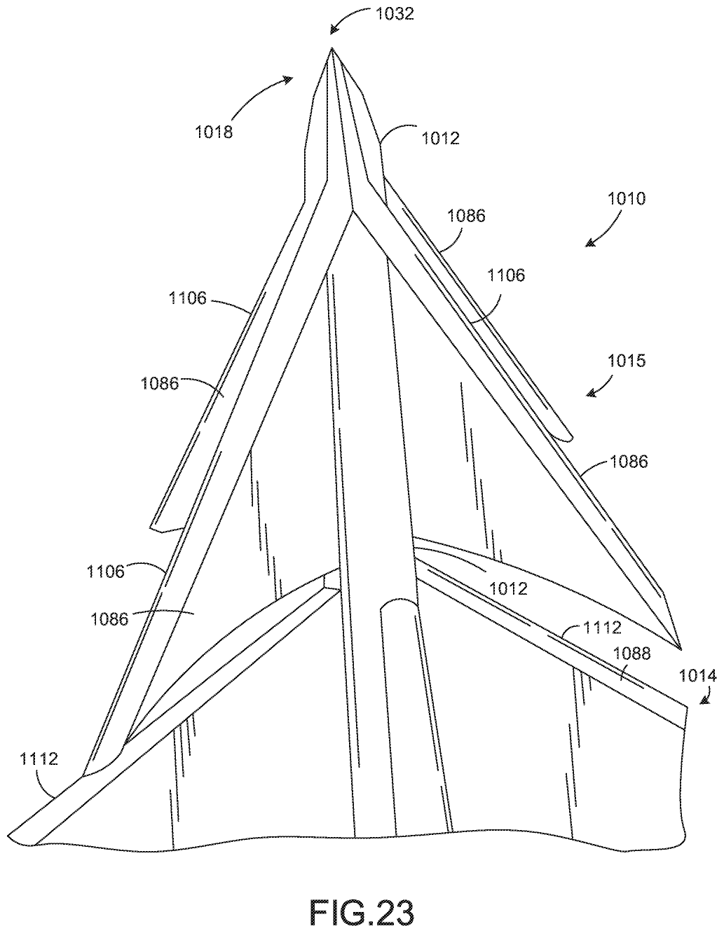

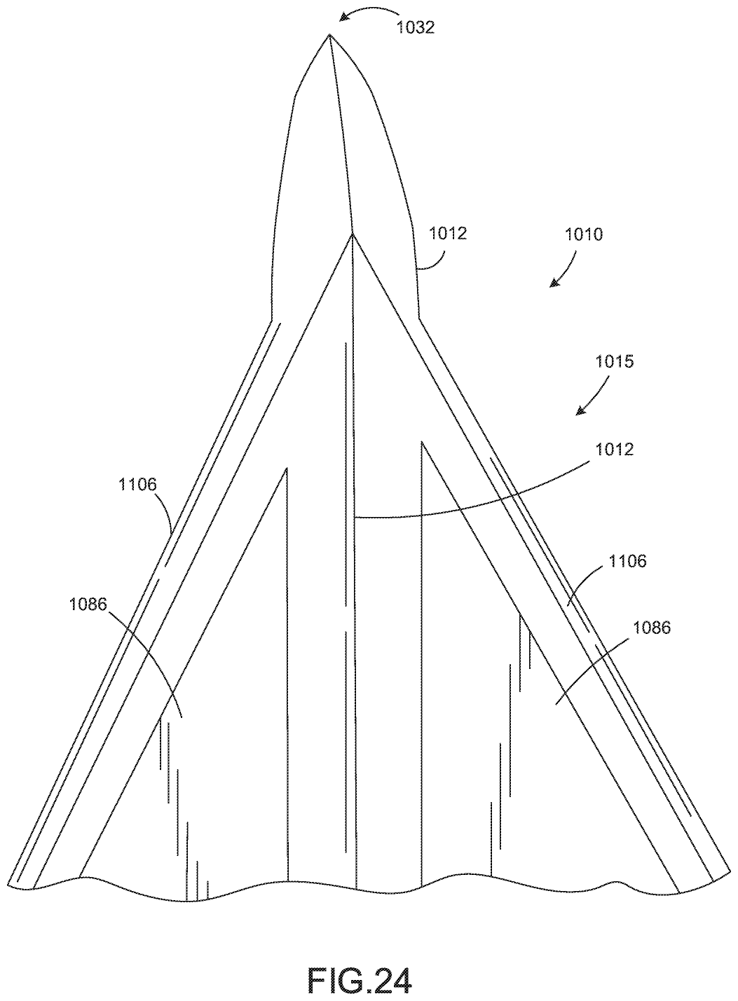

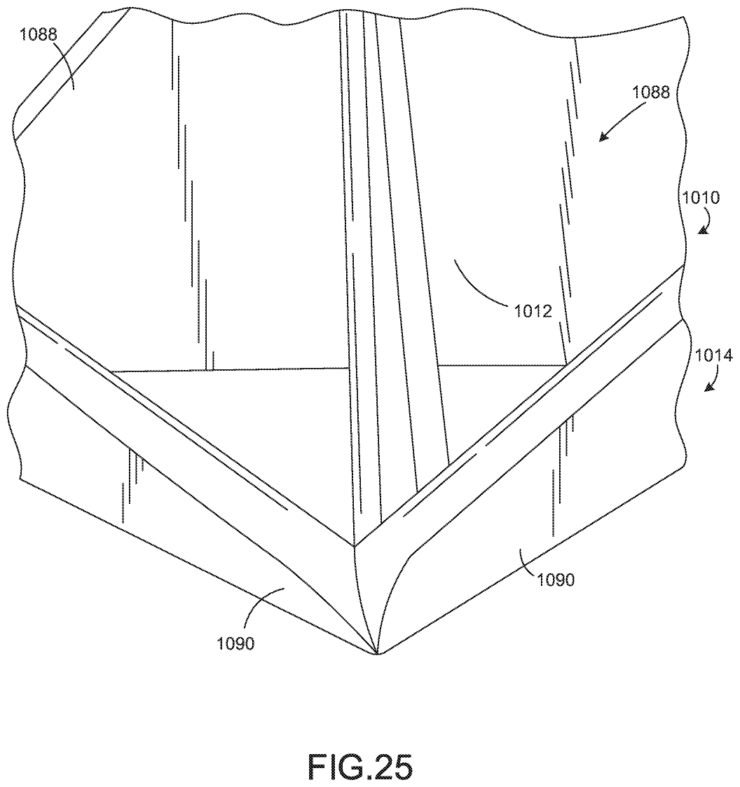

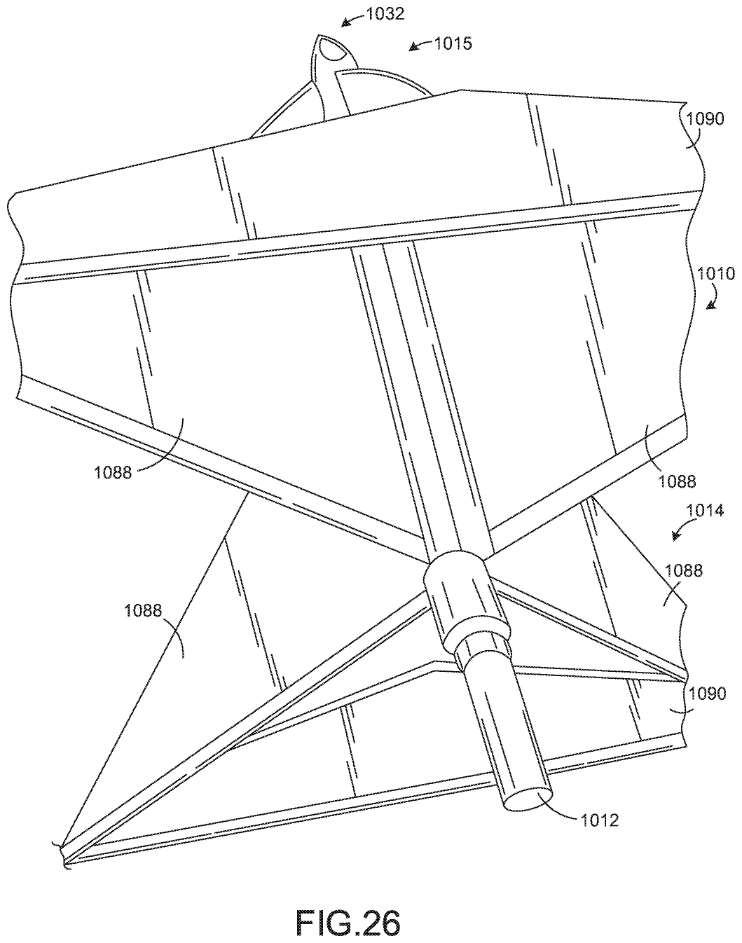

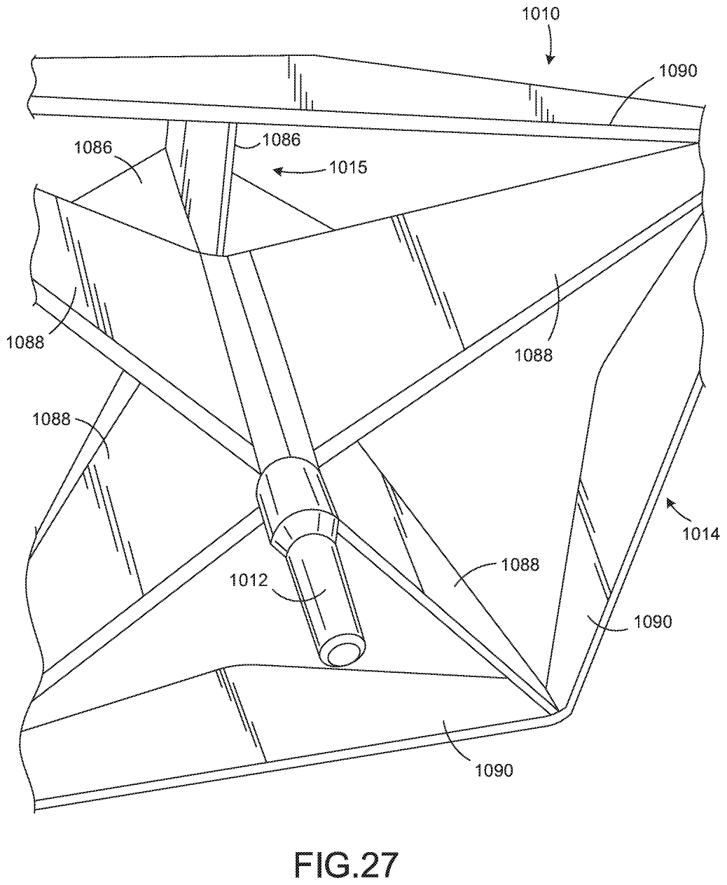

FIGS. 21, 22, 23, 24, 25, 26, and 27 illustrate another example impact tool 1010. The impact tool 1010 is similar to the impact tool 410 illustrated in FIGS. 10, 11, 12, and 13 and described above, except as detailed below.

In the illustrated embodiment, the impact tool 1010 includes a first elongate member 1012, a first impact member 1014, a second impact member 1015, and a plurality of impact member support member 1088. The first elongate member 1012 defines a projection 1032 on the first elongate member second end 1018.

In the illustrated embodiment, the first impact member 1014 has a length 1083, a width 1085, a rectangular cross-sectional configuration, is attached to the first elongate member 1012 by the plurality of impact member support member 1088, and has a plurality of first impact member elongate members 1090. Each first impact member elongate member of the plurality of first impact member elongate members 1090 has a first end 1092, a second end 1094, a width 1095 that tapers from a location between the first and second ends 1092, 1094 to the second end 1094, a first sharpened edge 1096, and a second sharpened edge 1098. The second impact member 1015 has a plurality of impact member blades 1086. Each blade of the plurality of impact member blades 1086 has a first end 1102, a second end 1104, a width 1101 that tapers from the first end 1002 to the second end 1104, and is attached to the first elongate member 1012. Each blade of the plurality of impact member blades 1086 has a sharpened edge 1106. In the illustrated embodiment, each blade of the plurality of impact member blades 1086 is positioned on a hypothetical plane that is disposed between a first impact member support member of the plurality of impact member support members 1088 and a second impact member support member of the plurality of impact member support members 1088. However, in alternative embodiments, a blade of the plurality of impact member blades can be positioned on a hypothetical plane that contains an impact member support member of a plurality of impact member support members.

Each impact member support member of the plurality of impact member support members 1088 has a first end 1108 attached to the impact member first frame 1084, a second end 1110 attached to the first elongate member 1012, and a width 1111 that tapers from the first end 1108 to the second end 1110. Each impact member support member of the plurality of impact member support members 1088 has a sharpened edge 1112. Any suitable technique or method of attachment can be used to accomplish the attachments described herein, such as the techniques and methods described herein.

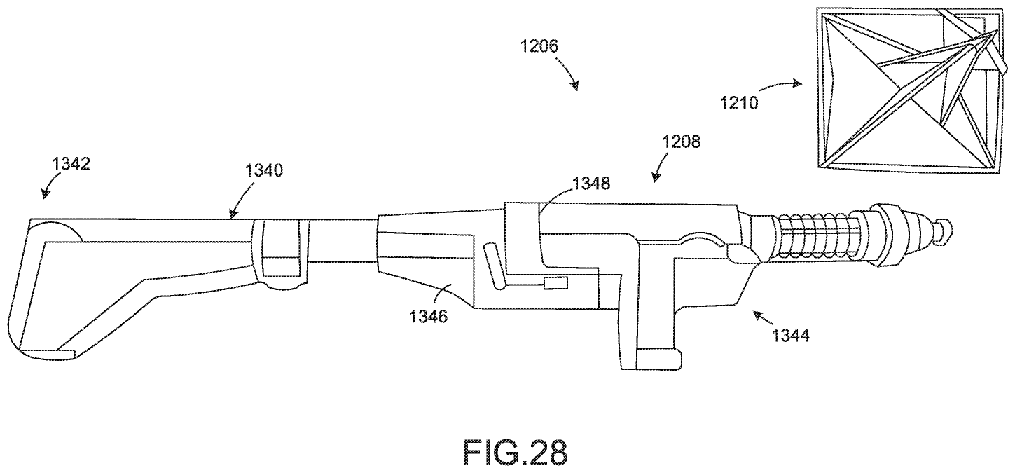

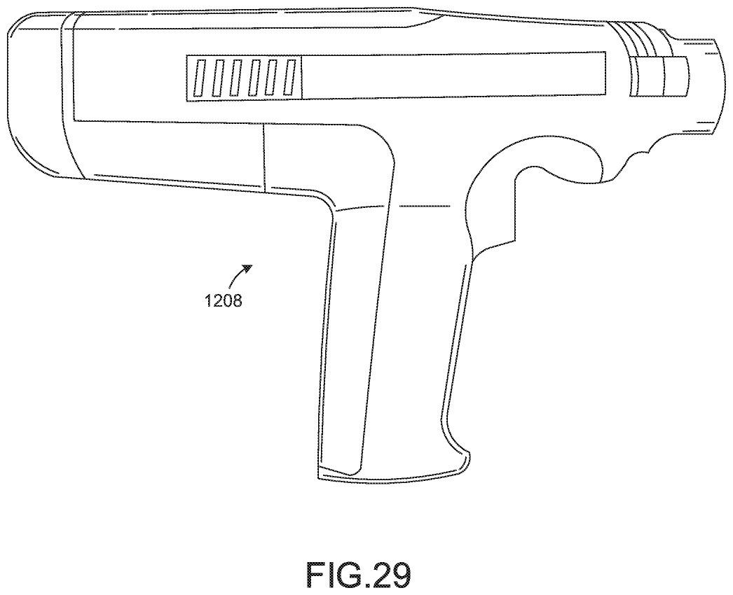

FIGS. 28 and 29 illustrate another example impact tool system 1206. The impact tool system 1206 is similar to the impact tool system 606 illustrated in FIG. 15 and described above, except as detailed below. The impact tool system 1206 includes an impact device 1208, an impact tool 1210, and a housing 1340. The impact tool 1210 is similar to the impact tool 610 illustrated in FIG. 15.

In the illustrated embodiment, the impact device 1208 is releasably disposed within the housing 1340. The housing 1340 has a first end 1342, a second end 1344, and a main body 1346 that defines a recess 1348 size and configured to receive the impact device 1208. The inclusion of a housing 1340 is considered advantageous at least because it allows a user to position the first end 1342 of the housing 1340 on a user's shoulder to increase the accuracy of the system 1206 during use.

Those with ordinary skill in the art will appreciate that various modifications and alternatives for the described and illustrated examples can be developed in light of the overall teachings of the disclosure, and that the various elements and features of one example described and illustrated herein can be combined with various elements and features of another example without departing from the scope of the invention. Accordingly, the particular examples disclosed herein have been selected by the inventor simply to describe and illustrate examples of the invention and are not intended to limit the scope of the invention or its protection, which is to be given the full breadth of the appended claims and any and all equivalents thereof.

What is claimed is:

1. An impact tool comprising:
a first elongate member having a first elongate member first end and a first elongate member second end; and
an impact member attached to the first elongate member, the impact member having an impact member first end, an impact member second end, an impact member length extending from the impact member first end to the impact member second end, an impact member first side, an impact member second side, and a plurality of projections disposed on the impact member second side and along the impact member length, each projection of the plurality of projections having a first end attached to the impact member and a second end, the plurality of projections configured on the impact member such that at least two projections of the plurality of projections intersect a first hypothetical plane disposed between the impact member second side and the second end of each projection of the plurality of projections.

2. The impact tool of claim 1, wherein the first elongate member has a solid cross-sectional configuration.

3. The impact tool of claim 1, wherein the first elongate member is a tubular member.

4. The impact tool of claim 1, wherein the impact member has an L-shaped cross-sectional configuration.

5. The impact tool of claim 1, wherein the impact member is attached to the first elongate member second end.

6. The impact tool of claim 1, wherein the impact member length has a midpoint; and
wherein the impact member is attached to the first elongate member at the midpoint.

7. The impact tool of claim 1, wherein the impact member is welded to the first elongate member.

8. The impact tool of claim 1, further comprising a first support member attached to the first elongate member and the impact member.

9. The impact tool of claim 8, further comprising a second support member attached to the first elongate member and the impact member.

10. The impact tool of claim 9, wherein the first support member is welded to each of the first elongate member and the impact member; and
wherein the second support member is welded to each of the first elongate member and the impact member.

11. The impact tool of claim 1, wherein each projection of the plurality of projections is welded to the impact member.

12. The impact tool of claim 1, wherein the first elongate member is formed of a first material and the impact member is formed of a second material that is different than the first material.

13. The impact tool of claim 12, wherein each projection of the plurality of projections has a main body and a tip, the main body formed of a third material and the tip formed of a fourth material that is different than the third material.

14. The impact tool of claim 13, wherein the third material is different than the second material.

15. The impact tool of claim 1, wherein the first elongate member is formed of a first material and the impact member is formed of a second material that is the same as the first material.

16. The impact tool of claim 15, wherein each projection of the plurality of projections has a main body and a tip, the main body formed of a third material and the tip formed of a fourth material that is different than the third material.

17. The impact tool of claim 16, wherein the third material is the same as the second material.

18. The impact tool of claim 17, wherein the first material is stainless steel; and
wherein the fourth material is a carbide.

19. An impact tool comprising:
a first elongate member having a first elongate member first end, a first elongate member second end, a first elongate member lengthwise axis, and a first elongate member length extending from the first elongate member first end to the first elongate member second end;
an impact member attached to the first elongate member second end, the impact member having an L-shaped cross-sectional configuration, an impact member first end, an impact member second end, an impact member lengthwise axis, an impact member length extending from the impact member first end to the impact member second end, an impact member first side, an impact member second side, and a plurality of projections disposed on the impact member second side and along the impact member length, the impact member length being less than the first elongate member length, each projection of the plurality of projections having a first end attached to the impact member and a second end, the plurality of projections configured on the impact member such that at least two projections of the plurality of projections intersect a first hypothetical plane disposed between the impact member second side and the second end of each projection of the plurality of projections, each projection of the plurality of projections having a main body and a tip, the main body formed of a first material and the tip formed of a second material that is different than the first material;
a first support member attached to the first elongate member and the impact member; and
a second support member attached to the first elongate member and the impact member.

20. An impact tool comprising:
a first elongate member having a first elongate member first end and a first elongate member second end;
an impact member attached to the first elongate member second end, the impact member having an impact member first end, an impact member second end, an impact member first side, an impact member second side, an impact member first frame, an impact member second frame, a plurality of impact member support members attached to each of the impact member first frame and the impact member second frame, and a plurality of projections disposed on the impact member second side, each projection of the plurality of projections having a first end attached to the impact member and a second end, the plurality of projections configured on the impact member such that at least two projections of the plurality of projections intersect a first hypothetical plane disposed between the impact member second end and the second end of each projection of the plurality of projections.
